(19) United States
(12) Patent Application Publication
(10) Pub. No.: US 2021/0079589 A1
(43) Pub. Date: Mar. 18, 2021

(54) PROCESS FOR PREPARING CATIONIC REGENERATED CELLULOSIC FIBERS

(71) Applicant: GRASIM INDUSTRIES LIMITED, Nagda (IN)

(72) Inventors: Vishvajit C Juikar, Panvel (IN); Dhrubajyoti Kalita, Navi Mumbai (IN); Vikas Chavan, Panvel (IN)

(73) Assignee: GRASIM INDUSTRIES LIMITED, Nagda (IN)

(21) Appl. No.: 17/042,049

(22) PCT Filed: Mar. 25, 2019
(86) PCT No.: PCT/IB2019/052386

§ 371 Date: Sep. 25, 2020

(30) Foreign Application Priority Data
Mar. 26, 2018 (IN) 201821011103

(51) Int. Cl. D06M 13/46; C11D 3/00; C11D 3/22; B01J 20/24

(52) U.S. Cl. CPC D06M 13/46; C11D 3/0021; D06M 2101/06; B01J 20/24; C11D 3/227

(57) ABSTRACT

A process for continuous production of a cationic regenerated cellulosic fiber comprises providing a wet regenerated cellulosic fiber; treating said regenerated cellulosic fiber with an alkaline solution of 3-halo-2-hydroxyalkyl-N,N,N-tri-alkyl or aryl substituted ammonium compound having the general Formula I, or a salt thereof while maintaining a pH of around 9-13:

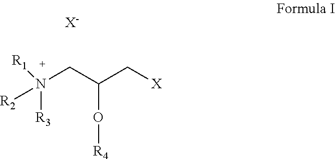

wherein X is a halogen selected from chloride or bromide; R1, R2, R3, are individually selected from a group consisting of C1-C4 alkyl, benzyl and substituted benzyl groups; and R4 is hydrogen; subjecting the treated regenerated cellulosic fiber to a moisture regulating step such that the moisture content in the treated cellulosic fiber is not more than 120% of weight of the treated cellulosic fiber; and curing the treated cellulosic fiber at a temperature ranging between 100° C. and 145° C., to obtain regenerated cellulosic fiber which is cationically modified.

### FIELD OF INVENTION

The present disclosure relates to a process for continuous production of cationic regenerated cellulosic fiber.

### BACKGROUND

The problem of discolouration of white or coloured fabric by a foreign or extraneous dye during washing is well known in home and industrial laundering. This extraneous dye not only renders the affected fabric unsuitable for further use but also poses a threat to water from laundry wash water and commercial dye houses. The undesirable discoloration during laundering occurs when dye from fabrics which have been dyed with dyes of poor wash fastness dissociates and migrates to wash solution and is absorbed on other fabrics being washed along with. This extraneous dye in the wash solution is commonly referred to as “fugitive” dyes and the dye carry-over from one fabric to another is commonly referred to as “dye transfer”.

Various attempts have been made to overcome the problem of dye transfer. Such attempts include avoiding simultaneous washing of clothes of different colours, improving affinity of a dye for the original fabric, use of dye transfer inhibitors to deactivate the leached dye. One approach including use of specifically treated fabrics as colour scavengers or colour-catchers to avoid redeposition of extraneous dyes onto clothes has become more widespread.

For instance, dye catcher sheets have been observed to offer the advantage of attracting and binding leached or extraneous dyes during washing. These dye catcher sheets are made by cationization of fabric with polymeric/monomeric additives and curing. However, as these are manufactured by cationization of fabrics/non-woven sheets, they cause a lot of chemical wastage to manufacturers and have very low dye catching efficiency. This dye catching efficiency is measured as Dye Pick Up (DPU). The DPU is considered as the amount of dye removed from the solution and adsorbed by the treated fiber and is expressed in mg of dye per one gram of the sample fiber/fabric made from this fiber.

U.S. Pat. No. 4,380,453 discloses use of a textile substrate (fabric or cloth) impregnated with a dye scavenging material such as N-trisubstituted ammonium 2 hydroxy 3 halopropryl compounds or salts of epoxy propyl ammonium compounds such as glycidyltrimethylammonium chloride, for controlling extraneous free flowing dyes or colorants in a liquid bath. U.S. Pat. No. 6,117,191 discloses a method for the production of a dye scavenging substrate in which a cellulosic substrate is coated with an alkaline solution of an N-trisubstituted ammonium 2-hydroxy-3-halopropyl compound, such as glycidyl-trimethylammonium chloride. However, such known methods suffer from disadvantages such as unstable reactant, non-uniformity of the coating process, cumbersome process conditions such as high pressures, temperatures and longer reaction times, low efficacy, batch process and requirement of maintaining efficacy over lifetime of the fabric in entire coating process. Particularly, in most of the prior known processes the substrate used for imparting dye scavenging material is either a textile or a non-woven fabric, which lead to non-uniform coating of the dye scavenging material thereby reducing the efficacy.

Thus, there is a need for an improved process of manufacturing cellulosic fibers which have high affinity towards dyes, while simultaneously avoiding disadvantages associated with the prior art processes.

### SUMMARY

A process for continuous production of a cationic regenerated cellulosic fiber is disclosed. Said process comprises the steps of:
(a) providing a wet regenerated cellulosic fiber;
(b) treating said regenerated cellulosic fiber with an alkaline solution of 3-halo-2-hydroxyalkyl-N,N,N-tri-alkyl or aryl substituted ammonium compound having the general formula I, or a salt thereof while maintaining a pH of around 9-13:

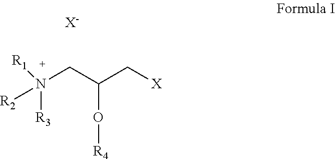

wherein
X is a halogen selected from a group consisting of chloride and bromide;
R1, R2, R3, are individually selected from a group consisting of C1-C4 alkyl, benzyl and substituted benzyl groups; and
R4 is hydrogen;
(c) subjecting the treated regenerated cellulosic fiber to a moisture regulating step such that the moisture content in the treated cellulosic fiber is not more than 120% of weight of the treated cellulosic fiber; and
(d) curing the treated cellulosic fiber at a temperature ranging between 100° C. and 145° C., to obtain regenerated cellulosic fiber which is cationically modified by 3-halo-2-hydroxyalkyl-N,N,N-tri-alkyl or aryl substituted ammonium compound having formula I, or a salt thereof in an amount ranging between 1.5 to 33% by weight of the cellulosic fiber.

A cationic regenerated cellulosic fiber is disclosed. Said cationic regenerated cellulosic fiber comprises regenerated cellulosic fiber cationically modified by 1.5 to 33% by weight of 3-halo-2-hydroxyalkyl-N,N,N-tri-alkyl or aryl substituted ammonium compound having formula I, or a salt thereof:

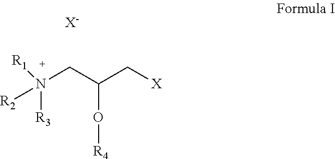

wherein
X is a halogen selected from a group consisting of chloride and bromide;
R1, R2, R3, are individually selected from a group consisting of C1-C4 alkyl, benzyl and substituted benzyl groups; and
R4 is hydrogen.

### DETAILED DESCRIPTION

For the purpose of promoting an understanding of the principles of the disclosure, reference will now be made to embodiments and specific language will be used to describe the same. It will nevertheless be understood that no limitation of the scope of the disclosure is thereby intended, such alterations and further modifications in the disclosed composition and method, and such further applications of the principles of the disclosure therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “one embodiment” “an embodiment” or similar language means that a particular feature, structure, or characteristic described in connection with the embodiment is included in at least one embodiment of the present disclosure. Thus, appearances of the phrase “in one embodiment”, “in an embodiment” and similar language throughout this specification may, but do not necessarily, all refer to the same embodiment.

In its broadest scope, the present disclosure relates to a process for continuous production of cationic regenerated cellulosic fiber. In particular, the present disclosure relates to a process for continuous production of cationic regenerated cellulosic fiber comprising the steps of:
(a) providing a wet regenerated cellulosic fiber;
(b) treating said regenerated cellulosic fiber with an alkaline solution of 3-halo-2-hydroxyalkyl-N,N,N-tri-alkyl or aryl substituted ammonium compound having the general formula I, or a salt thereof while maintaining a pH of around 9-13:

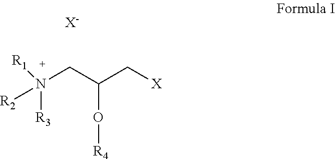

wherein
X is a halogen selected from a group consisting of chloride and bromide; R1, R2, R3, are individually selected from a group consisting of C1-C4 alkyl, benzyl and substituted benzyl groups; and
R4 is hydrogen;
(c) subjecting the treated regenerated cellulosic fiber to a moisture regulating step such that the moisture content in the treated cellulosic fiber is not more than 120% of weight of the treated regenerated cellulosic fiber; and
(d) curing the treated regenerated cellulosic fiber to a temperature ranging between 100° C. and 145° C.

The resultant cationic regenerated cellulosic fiber comprises regenerated cellulosic fiber cationically modified by 3-halo-2-hydroxyalkyl-N,N,N-tri-alkyl or aryl substituted ammonium compound having formula I, or a salt thereof in an amount ranging between about 1.5 to 33% by weight of the cellulosic fiber, more preferably about 13 to 26% by weight of cellulosic fiber and most preferably about 16.25 to 24.7% by weight of cellulosic fiber. Such cationic regenerated cellulosic fiber has the ability to absorb a very high amount of direct dyes or reactive dyes. Thus, said cationic regenerated cellulosic fiber is suitable for manufacturing of fugitive dye absorbing fiber and article. Said fugitive dye absorbing fiber has a DPU ranging between 2-50 mg/g (mg of dye absorbed by one gram of fiber).

The present process results in improving the dyeability and dyeing fastness of the regenerated cellulosic fiber with direct dyes, reactive dyes and the like.

In accordance with an embodiment, said 3-halo-2-hydroxyalkyl-N,N,N-tri-alkyl or aryl substituted ammonium compound is selected from a group consisting of 3-chloro-2-hydroxypropyl trimethylammonium chloride, 3-chloro-2-hydroxypropyl-N,N,N-trimethylammonium bromide, 3-chloro-2-hydroxypropyl-N,N,-diethyl-N-methylammonium chloride, 3-chloro-2-hydroxypropyl-N,N,-dimethyl-N-benzylammonium chloride and mixtures thereof. In accordance with a preferred embodiment, said 3-halo-2-hydroxyalkyl-N,N,N-tri-alkyl or aryl substituted ammonium compound is 3-chloro-2-hydroxypropyl trimethylammonium chloride.

In accordance with an embodiment, said alkaline solution of 3-halo-2-hydroxyalkyl-N,N,N-tri-alkyl or aryl substituted ammonium compound is applied to the wet cellulosic fiber in an amount ranging from 15-30% by weight of the cellulosic fiber, and preferably from about 18 to 25% by weight of the cellulosic fiber.

In accordance with an embodiment, said alkaline solution of 3-halo-2-hydroxyalkyl-N,N,N-tri-alkyl or aryl substituted ammonium compound has a concentration of 3-halo-2-hydroxyalkyl-N,N,N-tri-alkyl or aryl substituted ammonium compound ranging between 13 to 26%, and preferably 16.25 to 24.7%.

In accordance with an embodiment, the alkaline solution has a concentration of from 3.25 to 6.5%. Said alkaline solution comprises a base selected from a group consisting of sodium hydroxide, potassium hydroxide, sodium carbonate, and preferably sodium hydroxide or potassium hydroxide.

In accordance with an embodiment, the alkaline solution 3-halo-2-hydroxyalkyl-N,N,N-tri-alkyl or aryl substituted ammonium compound is maintained at a temperature between about 10 to 50° C., and preferably between about 20 to 40° C. In accordance with an embodiment, the cellulosic fiber is treated with the alkaline solution of 3-halo-2-hydroxyalkyl-N,N,N-tri-alkyl or aryl substituted ammonium compound for a time period of less than 10 minutes.

In accordance with an embodiment, dye pick up of the regenerated cellulosic fiber can be improved by varying the degree of cationization. The degree of cationization can be varied by by varying at least one of pH, temperature of curing, concentration of chemical and time of curing.

In accordance with an embodiment, curing of the treated regenerated cellulosic fiber is carried out at a temperature ranging between 100° C. and 145° C., and preferably between 110° C. and 135° C.

In accordance with an embodiment, the moisture regulating step comprises of any known method of altering the moisture content of cellulosic fiber. In accordance with an exemplary embodiment, the moisture content of cellulosic fiber is regulated by dewatering the regenerated cellulosic fiber by passing the regenerated cellulosic fiber between a pair of rollers.

In accordance with an embodiment, the wet regenerated cellulosic fiber is a never-dried regenerated cellulosic fiber obtained from standard viscose manufacturing process. The present disclosure also provides a process for preparing cationic regenerated cellulosic fibers from a cellulosic solution through a viscose process. Said process comprises the steps of:
(a) spinning a cellulosic solution through a spinneret into a regeneration bath to obtain regenerated cellulosic fibers;
(b) washing the regenerated cellulosic fibers to obtain never dried regenerated cellulosic fiber;
(c) treating the never dried regenerated cellulosic fibers with an alkaline solution of 3-halo-2-hydroxyalkyl-N,N,N-tri-alkyl or aryl substituted ammonium compound having the general formula I, or a salt thereof

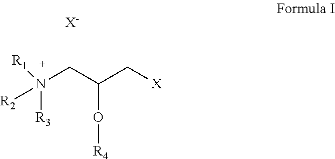

wherein
X is a halogen selected from a group consisting of chloride and bromide;
R1, R2, R3, are individually selected from a group consisting of C1-C4 alkyl, benzyl and substituted benzyl groups; and
R4 is hydrogen; and
(d) curing the resultant fibers to obtain cationic regenerated cellulosic fibers.

In accordance with an embodiment, said regenerated cellulosic fibers are selected from viscose or modal or lyocell. These fibers are prepared either by viscose process or solvent spun process. The viscose was prepared by treatment of pulp sheets (high alpha cellulose, viscose grade pulp) with caustic soda followed by shredding thereof in alkali cellulose, xanthating the alkali cellulose and dissolving it in a caustic soda solution. The viscose was then aged and spun by extrusion through orifices into a spinning bath containing sulfuric acid, sodium sulfate and zinc sulfate. The spinning bath was maintained at a temperature of 30-50° C. The filaments were withdrawn from the bath and passed over a first and second godets, and were then collected. After collecting the filaments, they were washed, desulfurized and bleached by conventional treatments. Similarly, regenerated cellulosic fibers can also be obtained from standard Lyocell process i.e. solvent spun process.

In accordance with an embodiment, the wet regenerated cellulosic fiber is obtained by re-wetting dried regenerated cellulosic fibers.

In accordance with an embodiment, the wet regenerated cellulosic fiber is laid on moving bed.

An absorbent article comprising said cationic regenerated cellulosic fiber is also disclosed. Said absorbent article comprises about 1 to 100% of said cationic regenerated cellulosic fiber. Said absorbent article includes but is not limited to fugitive dye absorbing articles, or wovens or non-wovens, sheets, powder, filters and the like.

### Specific Embodiments are Described Below

A process for continuous production of a cationic regenerated cellulosic fiber, said process comprising the steps of:
(a) providing a wet regenerated cellulosic fiber;
(b) treating said regenerated cellulosic fiber with an alkaline solution of 3-halo-2-hydroxyalkyl-N,N,N-tri-alkyl or aryl substituted ammonium compound having the general formula I, or a salt thereof while maintaining a pH of around 9-13:

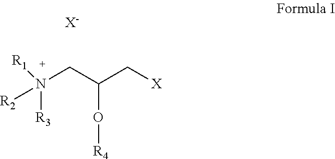

wherein
X is a halogen selected from a group consisting of chloride and bromide;
R1, R2, R3, are individually selected from a group consisting of C1-C4 alkyl, benzyl and substituted benzyl groups; and
R4 is hydrogen;
(c) subjecting the treated regenerated cellulosic fiber to a moisture regulating step such that the moisture content in the treated cellulosic fiber is not more than 120% of weight of the treated cellulosic fiber; and
(d) curing the treated cellulosic fiber at a temperature ranging between 100° C. and 145° C., to obtain regenerated cellulosic fiber which is cationically modified by 3-haloalkyl-2-hydroxy-N-tri-alkyl or aryl substituted ammonium compound having formula I, or a salt thereof in an amount ranging between 1.5-33% by weight.

Such process, wherein 3-halo-2-hydroxyalkyl-N,N,N-tri-alkyl or aryl substituted ammonium compound is selected from a group consisting of 3-chloro-2-hydroxypropyl trimethylammonium chloride, 3-chloro-2-hydroxypropyl-N,N,N-trimethylammonium bromide, 3-chloro-2-hydroxypropyl-N,N,-diethyl-N-methylammonium chloride, 3-chloro-2-hydroxypropyl-N,N,-dimethyl-N-benzylammonium chloride and mixtures thereof.

Such process, wherein 3-halo-2-hydroxyalkyl-N,N,N-tri-alkyl or aryl substituted ammonium compound is 3-chloro-2-hydroxypropyl trimethylammonium chloride.

Such process, wherein said alkaline solution of 3-halo-2-hydroxyalkyl-N,N,N-tri-alkyl or aryl substituted ammonium compound is applied to the wet regenerated cellulosic fiber in an amount ranging from 15-30% by weight of the cellulosic fiber.

Such process, wherein said alkaline solution of 3-halo-2-hydroxyalkyl-N,N,N-tri-alkyl or aryl substituted ammonium compound has a concentration of 3-haloalkyl-2-hydroxy-N-trialkyl substituted ammonium compound ranging between 13 to 26%.

Such process, wherein said alkaline solution comprises a base selected from a group consisting of sodium hydroxide, potassium hydroxide and sodium carbonate.

Such process, wherein the alkaline solution of 3-halo-2-hydroxyalkyl-N,N,N-tri-alkyl or aryl substituted ammonium compound is maintained at a temperature of between about 10 to 50° C.

Such process, wherein the wet regenerated cellulosic fiber is treated with the alkaline solution of 3-halo-2-hydroxyalkyl-N,N,N-tri-alkyl or aryl substituted ammonium compound for a time period of less than 10 minutes.

Such process, wherein curing of the treated regenerated cellulosic fiber is carried out at a temperature ranging between 110-135° C.

Such process, wherein the wet regenerated cellulosic fiber is a never-dried regenerated cellulosic fiber obtained by spinning a cellulosic solution through spinneret into a regeneration bath and washing the regenerated cellulosic fiber.

Such process, wherein the wet regenerated cellulosic fiber is obtained by re-wetting dried regenerated cellulosic fibers.

Such process, wherein the wet regenerated cellulosic fiber is selected from a group consisting of viscose staple fiber, modal fiber, lyocell fiber and mixtures thereof.

Such process, wherein the wet regenerated cellulosic fiber is laid on moving bed.

A cationic regenerated cellulosic fiber comprising regenerated cellulosic fiber cationically modified by 1.5 to 33% by weight of 3-halo-2-hydroxyalkyl-N,N,N-tri-alkyl or aryl substituted ammonium compound having formula I, or a salt thereof:

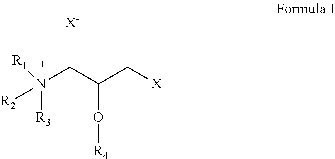

wherein
X is a halogen selected from a group consisting of chloride and bromide;
R1, R2, R3, are individually selected from a group consisting of C1-C4 alkyl, benzyl and substituted benzyl groups; and
R4 is hydrogen.

Such cationic regenerated cellulosic fiber, wherein 3-halo-2-hydroxyalkyl-N,N,N-tri-alkyl or aryl substituted ammonium compound is selected from a group consisting of 3-chloro-2-hydroxypropyl trimethylammonium chloride, 3-chloro-2-hydroxypropyl-N,N,N-trimethylammonium bromide, 3-chloro-2-hydroxypropyl-N,N,-diethyl-N-methylammonium chloride, 3-chloro-2-hydroxypropyl-N,N,-dimethyl-N-benzylammonium chloride and mixtures thereof.

Such cationic regenerated cellulosic fiber, wherein 3-halo-2-hydroxyalkyl-N,N,N-tri-alkyl or aryl substituted ammonium compound is 3-chloro-2-hydroxypropyl trimethylammonium chloride.

An absorbent article comprising said cationic regenerated cellulosic fiber.

### EXAMPLES

### Example 1: Preparation of Fugitive Dye Absorbing Fiber

Preparation: Never dried regenerated cellulosic fiber with ˜90-120% moisture was used. An alkaline solution of 3-chloro-2-hydroxypropyl-N,N,N-trimethylammonium chloride (CHPTAC) is prepared at various concentrations at 25-30° C. and poured/sprayed/applied from above to a moving bed of wet fiber with continuous recirculation. The fiber bed is squeezed to 70-120% moisture content before drying at 120-145° C., to obtain disclosed fugitive dye absorbing fiber.

### Measurement of Effectiveness:

### Method A: Visual Method

Visual method was a quick screening method to ascertain the affinity of the fibers towards direct dyes, where a comparative rating is attributed to the remaining dye in a solution in a scale of 0-100. Briefly, 180 mg of Saiamine LF sky Blue FH dye was dissolved in 1 litre of hot water (at 40±1° C.) to obtain a dye bath with concentration of 180 mg/L. Different standards were made as represented in the Table 1. For the test, 1.0 gram of fiber was dipped in 140 mL of dye bath (containing 25.2 mg of dye) at 40° C., by continuous stirring manually. At the end of 1 minute, the colored fiber is removed from dye bath and the solution filtered using nylon filter to remove suspended fiber. Table 1 shows the method of preparation of DPU standards (by mixing test solution and DM water at specific ratios) for a quick comparison of tested solution with different standards. Tested solution after filtration is compared against the closest match of the standard and assigned a DPU value.

TABLE 1

| | DPU standard | Test solution of 180 mg/L | DM water |
|---|---|---|---|
| DPU standard | (% DPU) | (mL) | (mL) |
| Satndard 1 | 100 | 0 | 50 |
| Satndard 2 | 98 | 1 | 49 |
| Standard 3 | 95 | 2.5 | 47.5 |
| Standard 4 | 92 | 4 | 46 |
| Standard 5 | 88 | 6 | 44 |
| Standard 6 | 84 | 8 | 42 |
| Standard 7 | 80 | 10 | 40 |
| Standard 8 | 75 | 12.5 | 37.5 |
| Standard 9 | 70 | 15 | 35 |
| Standard 10 | 60 | 20 | 30 |
| Standard 11 | 50 | 25 | 25 |

### Method B: Spectroscopic Method

Spectrophotometric determination of remaining dye in the dye bath is more accurate method as compared to visual method to quantify the dye uptake. A dye bath of a Direct red F3B 150% Dye is prepared by diluting 50 mg of dye in 1 L of water to receive a dye bath with a concentration of 50 mg/L. The fugitive dye absorbing sheet/fiber is placed in 750 ml of the above mentioned dye bath at 40±1° C. in a glass beaker under continuous constant agitation and constant temperature. After every minute, an aliquot of dye solution was removed, and the effectiveness of prepared fugitive dye absorbing sheet was tested by measuring the dye concentration in the residual liquor by UV-Vis spectrophotometry at 538 nm. Calibration curve was generated in the range of 1-50 mg/L concentration of the dye.

### Method C: Kjeldahl Nitrogen Analysis

This method determines the nitrogen contents in organic and inorganic substances. The amount of dye uptake by the fibers is a direct measurement of its effectiveness, which also has a direct correlation with the covalently bound nitrogen. Fiber/Chemical digested and analyzed by standard Kjeldahl instrument. (Reference: Kjeldahl, J. (1883) “Neue Methode zur Bestimmung des Stickstoffs in organischen Korpern” (New method for the determination of nitrogen in organic substances), Zeitschrift für analytische Chemie, 22 (1): 366-383.)

Table 2 shows a comparison between the DPU of the fugitive dye absorbing fiber, at various concentrations of CHPTAC and using Method A and Method B.

TABLE 2

| S. No. | CHPTAC (%) | DPU (Method A) | DPU (Method B) |
|---|---|---|---|
| 1 | 33.0 | 99-100 | 45.7 |
| 2 | 26.0 | 98 | 36.7 |
| 3 | 22.8 | 96 | 32.0 |
| 4 | 16.3 | 90 | 22.3 |
| 5 | 9.8 | <70 | 13.1 |
| 6 | 6.5 | <60 | 10.0 |
| 7 | 4.0 | <50 | 7.0 |
| 8 | 1.6 | <50 | 2.9 |

NT: Not tested

The performance of a fugitive dye absorbing sheet/fiber sheet in accordance with an embodiment of the present invention was also evaluated by comparing it with commercially available colour-catcher articles having same weight of fiber. Table 3 shows a comparative summary of DPU of commercially available color catcher products that comprises of mixture of cellulosic fibers or pulp and/or synthetic fibers (COMP-1 and COMP-2) and disclosed fugitive dye absorbing sheet/fibers, (DC VSF—Dye Catcher VSF having varying percentages of CHPTAC) using Method B.

TABLE 3

| | | DPU (mg/g of fiber/ |
|---|---|---|
| S. No. | Fabric detail | fabric) at 3 minutes |
| 1 | COMP-1 | 25 |
| 2 | COMP-2 | 18.9 |
| 3 | DCVSF 1 (13.0-6.25%) | 22.3 |
| 4 | DCVSF 2 (19.5-22.8%) | 32.0 |
| 5 | DCVSF 3 (24.7-26%) | 36.7 |

The below examples show the % reaction completion upon varying the curing temperature, time of curing (under controlled alkaline pH of 10-12), and pH and concentration of CHPTAC.

Example 2: Table 4 shows the % reaction completion (determined by Method C) vs temp. of curing for 9.8% of CHPTAC; Curing time: 10 minutes; pH 10.

TABLE 4

| S. No. | Curing temp. (° C.) | % reaction completion |
|---|---|---|
| 1 | 100 | 20.90 |
| 2 | 120 | 44.78 |
| 3 | 130 | 46.27 |
| 4 | 140 | 47.76 |

Example 3: Table 5 shows the % reaction completion (as determined by Method C) vs time of curing at 120° C. for 13.0% of CHPTAC; Constant pH 10.

TABLE 5

| S. No. | Curing time (Min) | % reaction completion |
|---|---|---|
| 1 | 10 | 26.32 |
| 2 | 20 | 35.11 |
| 3 | 30 | 38.30 |
| 4 | 120 | 50.00 |
| 5 | 300 | 51.06 |

Example 4: Table 6 shows the % reaction completion (as determined by Method C) vs pH and concentration of CHPTAC (%) solution at 120° C.; Curing time: 10 minutes.

TABLE 6

| | CHPTAC concentration | pH | % reaction |
|---|---|---|---|
| S. No. | (%) | (with NaOH) | completion |
| 1A | 6.5 | 10 | 27.12 |
| 1B | 6.5 | 13 | 37.74 |
| 2A | 13.0 | 10 | 26.47 |
| 2B | 13.0 | 13 | 29.41 |
| 3A | 19.5 | 10 | 22.86 |
| 3B | 19.5 | 13 | 29.86 |

### INDUSTRIAL APPLICABILITY

The disclosed process of preparing cationic regenerated cellulosic fiber is a continuous process and is simple and inexpensive to perform. The chemicals used in the present process are registered under REACH (Registration, Evaluation, Authorisation and Restriction of Chemicals) and hence disclosed process is an eco-friendly process.

The disclosed process performs the cationization of the cellulosic fiber at the wet stage. This provides advantage of uniform application of dye absorbing compound on the regenerated cellulosic fiber, accessibility to convert the fiber to cationic yarn, multiple dye catcher non-woven variants, lower effluent generation in commercial dye houses, and avoiding interference of residual chemicals as in post coating process. Further, efficacy is retained after downstream non-woven processes like spunlacing and melt bonding and also during conversion of fiber to yarn and then to fabric or textile.

The resultant cationic regenerated cellulosic fiber is suitable to make fugitive dye absorbing regenerated cellulosic fiber and articles. Said fugitive dye absorbing regenerated cellulosic fiber is suitable to make non-woven fabric (fugitive dye absorbing sheets) or textiles for use in commercial and domestic laundry houses for the purpose of removing undesirable extraneous dyes from the laundry wash water thus eliminating undesirable discolouration of other clothes. The present process also enables obtaining fugitive dye absorbing articles comprising blended cellulosic fiber with fibers like Polyester, Polylacticacid (PLA), Polypropylene (PP), Lyocel, and cotton.

The cationic regenerated cellulosic fiber of the present disclosure can also be used with direct and reactive dyes. Said cationic regenerated cellulosic fiber requires a salt free dyeing process.

1. A process for continuous production of a cationic regenerated cellulosic fiber, said process comprising the steps of:
(a) providing a wet regenerated cellulosic fiber;
(b) treating said regenerated cellulosic fiber with an alkaline solution of 3-halo-2-hydroxyalkyl-N,N,N-tri-alkyl or aryl substituted ammonium compound having the general formula I, or a salt thereof while maintaining a pH of around 9-13: 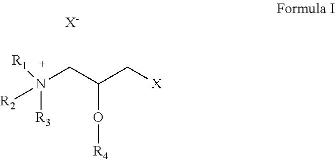
wherein
X is a halogen selected from a group consisting of chloride and bromide;
R1, R2, R3, are individually selected from a group consisting of C1-C4 alkyl, benzyl and substituted benzyl groups; and
R4 is hydrogen;
(c) subjecting the treated regenerated cellulosic fiber to a moisture regulating step such that the moisture content in the treated cellulosic fiber is not more than 120% of weight of the treated cellulosic fiber; and
(d) curing the treated cellulosic fiber at a temperature ranging between 100° C. and 145° C., to obtain regenerated cellulosic fiber which is cationically modified by 3-halo-2-hydroxyalkyl-N,N,N-tri-alkyl or aryl substituted ammonium compound having formula I, or a salt thereof in an amount ranging between 1.5 to 33% by weight.

2. The process as claimed in claim 1, wherein 3-halo-2-hydroxyalkyl-N,N,N-tri-alkyl or aryl substituted ammonium compound is selected from a group consisting of 3-chloro-2-hydroxypropyl trimethylammonium chloride, 3-chloro-2-hydroxypropyl-N,N,N-trimethylammonium bromide, 3-chloro-2-hydroxypropyl-N,N,-diethyl-N-methylammonium chloride, 3-chloro-2-hydroxypropyl-N,N,-dimethyl-N-benzylammonium chloride and mixtures thereof.

3. The process as claimed in claim 2, wherein 3-halo-2-hydroxyalkyl-N,N,N-tri-alkyl or aryl substituted ammonium compound is 3-chloro-2-hydroxypropyl trimethylammonium chloride.

4. The process as claimed in claim 1, wherein said alkaline solution of 3-halo-2-hydroxyalkyl-N,N,N-tri-alkyl or aryl substituted ammonium compound is applied to the wet regenerated cellulosic fiber in an amount ranging from about 15 to 30% by weight of the cellulosic fiber.

5. The process as claimed in claim 1, wherein said alkaline solution of 3-halo-2-hydroxyalkyl-N,N,N-tri-alkyl or aryl substituted ammonium compound has a concentration of 3-halo-2-hydroxyalkyl-N,N,N-tri-alkyl or aryl substituted ammonium compound ranging between about 13 to 26%.

6. The process as claimed in claim 1, wherein said alkaline solution comprises a base selected from a group consisting of sodium hydroxide, potassium hydroxide and sodium carbonate.

7. The process as claimed in claim 1, wherein the alkaline solution of 3-halo-2-hydroxyalkyl-N,N,N-tri-alkyl or aryl substituted ammonium compound is maintained at a temperature between about 10 to 50° C.

8. The process as claimed in claim 1, wherein the wet regenerated cellulosic fiber is treated with the alkaline solution of 3-halo-2-hydroxyalkyl-N,N,N-tri-alkyl or aryl substituted ammonium compound for a time period of less than 10 minutes.

9. The process as claimed in claim 1, wherein curing of the treated regenerated cellulosic fiber is carried out at a temperature ranging between about 110-135° C.

10. The process as claimed in claim 1, wherein the wet regenerated cellulosic fiber is a never-dried regenerated cellulosic fiber obtained by spinning a cellulosic solution through a spinneret into a regeneration bath and washing the regenerated cellulosic fiber.

11. The process as claimed in claim 1, wherein the wet regenerated cellulosic fiber is obtained by re-wetting a dried regenerated cellulosic fiber.

12. The process as claimed in claim 1, wherein the wet regenerated cellulosic fiber is selected from a group consisting of viscose staple fiber, modal fiber, lyocell fiber and mixtures thereof.

13. The process as claimed in claim 1, wherein the wet regenerated cellulosic fiber is laid on moving bed.

14. A cationic regenerated cellulosic fiber comprising regenerated cellulosic fiber cationically modified by 1.5 to 33% by weight of 3-halo-2-hydroxyalkyl-N,N,N-tri-alkyl or aryl substituted ammonium compound having formula I, or a salt thereof: 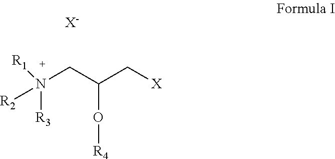
wherein
X is a halogen selected from a group consisting of chloride and bromide;
R1, R2, R3, are individually selected from a group consisting of C1-C4 alkyl, benzyl and substituted benzyl groups; and
R4 is hydrogen.

15. The cationic regenerated cellulosic fiber as claimed in claim 14, wherein 3-halo-2-hydroxyalkyl-N,N,N-tri-alkyl or aryl substituted ammonium compound is selected from a group consisting of 3-chloro-2-hydroxypropyl trimethylammonium chloride, 3-chloro-2-hydroxypropyl-N,N,N-trimethylammonium bromide, 3-chloro-2-hydroxypropyl-N,N,-diethyl-N-methylammonium chloride, 3-chloro-2-hydroxypropyl-N,N,-dimethyl-N-benzylammonium chloride and mixtures thereof.

16. The cationic regenerated cellulosic fiber as claimed in claim 14, wherein 3-halo-2-hydroxyalkyl-N,N,N-tri-alkyl or aryl substituted ammonium compound is 3-chloro-2-hydroxypropyl trimethylammonium chloride.

17. A cationic regenerated cellulosic fiber obtained using the process as claimed in claim 1.

18. An absorbent article comprising the cationic regenerated cellulosic fiber as claimed in claim 14.
